(19) United States
(12) Patent Application Publication
(10) Pub. No.: US 2026/0368446 A1
(43) Pub. Date: Nov. 19, 2026

(54) TASK-DRIVEN AI SUMMARIZATION FRAMEWORK FOR EDGE DEVICES

(71) Applicant: Samsung Electronics Co., Ltd., Suwon-si (KR)

(72) Inventor: Yuexi Zhang, Irvine, CA (US)

(21) Appl. No.: 19/645,790

(22) Filed: Apr. 13, 2026

Related U.S. Application Data
(60) Provisional application No. 63/808,447, filed on May 19, 2025.

(51) Int. Cl. G06F 40/40; G06F 40/166; G06V 10/774; G06V 10/776

(52) U.S. Cl. CPC G06F 40/40; G06F 40/166; G06V 10/774; G06V 10/776

(57) ABSTRACT

A method includes receiving an input using a language artificial intelligence (AI) model and outputting a summary based on the input using the language AI model. The language AI model is trained using a combination of a summary generation operation, a scoring operation, a feedback operation, and a summary re-generation operation. The feedback operation dynamically adjusts preferences used to influence summaries generated by the language AI model and provides real-time feedback for a generated summary created by the language AI model based on a training input.

### CROSS-REFERENCE TO RELATED APPLICATION AND PRIORITY CLAIM

This application claims priority under 35 U.S.C. § 119 (e) to U.S. Provisional Patent Application No. 63/808,447 filed on May 19, 2025, which is hereby incorporated by reference in its entirety.

### TECHNICAL FIELD

This disclosure relates generally to artificial intelligence (AI) systems. More specifically, this disclosure relates to a task-driven AI summarization framework for edge devices.

### BACKGROUND

Text summarization is a natural language processing (NLP) task that involves generating concise summaries of longer documents while preserving key information. It finds applications across various domains such as news aggregation, document summarization and social media analysis. Typically, text summarization approaches are categorized into extractive and abstractive methods based on how the output summary is generated. Extractive methods create summaries by extracting key sentences from the original input while the abstractive methods generate the summaries word-by-word with novel contents.

### SUMMARY

This disclosure relates to a task-driven AI summarization framework for edge devices.

In one embodiment, a method includes receiving an input using a language artificial intelligence (AI) model and outputting a summary based on the input using the language AI model. The language AI model is trained using a combination of a summary generation operation, a scoring operation, a feedback operation, and a summary re-generation operation. The feedback operation dynamically adjusts preferences used to influence summaries generated by the language AI model and provides real-time feedback for a generated summary created by the language AI model based on a training input.

In another embodiment, an electronic device includes at least one processing device configured to receive an input using a language artificial intelligence (AI) model and output a summary based on the input using the language AI model. The language AI model is trained using a combination of a summary generation operation, a scoring operation, a feedback operation, and a summary re-generation operation. The feedback operation dynamically adjusts preferences used to influence summaries generated by the language AI model and provides real-time feedback for a generated summary created by the language AI model based on a training input.

In yet another embodiment, a non-transitory machine-readable medium contains instructions that when executed cause at least one processor of an electronic device to receive an input using a language artificial intelligence (AI) model and output a summary based on the input using the language AI model. The language AI model is trained using a combination of a summary generation operation, a scoring operation, a feedback operation, and a summary re-generation operation. The feedback operation dynamically adjusts preferences used to influence summaries generated by the language AI model and provides real-time feedback for a generated summary created by the language AI model based on a training input.

Any single one or any combination of the following features may be used with the above embodiments. The summary generation operation can include training the language AI model using supervised loss in which rationales are generated based on the training input and the supervised loss includes a combination of a loss associated with the generated rationales and a loss associated with the generated summary. The scoring operation can evaluate, using a judgment large language model (LLM), the generated summary provided by the language AI model based on one or more defined evaluation metrics, and the judgment LLM can output one or more performance scores based on the one or more defined evaluation metrics. The one or more defined evaluation metrics can include one or more of a character grounding metric, a plot grounding metric, a plot correctness metric, a conciseness and completeness metric, and a duplication and repetition metric. The scoring operation can provide, using the judgment LLM, one or more suggestions based on the one or more defined evaluation metrics, and the one or more suggestions can be aggregated into an overall suggestion that is used by the feedback operation to dynamically adjust the preferences. The feedback operation can include an expert preference generation model configured to adaptively generate preferences as language model updates and a reward system to optimize the language model based on the generated preferences via a feedback loss function. Visual information can be provided, using a visual understanding model, to the language AI model and the summary can be generated based on the input using the visual information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example task-driven AI summarization architecture in accordance with this disclosure;

FIG. 3A illustrates an example training process in accordance with this disclosure;

FIG. 3B illustrates an example generation of example rationales from example input text in accordance with this disclosure;

FIG. 4 illustrates an example inferencing process in accordance with this disclosure;

FIG. 5 illustrates an example scoring process in accordance with this disclosure;

FIG. 6 illustrates an example feedback/refinement process in accordance with this disclosure;

FIG. 7 illustrates an example summarization process incorporating visual understanding in accordance with this disclosure;

FIG. 8 illustrates an example on-device content summarization process in accordance with this disclosure;

FIG. 9 illustrates an example training method for a language AI model in accordance with this disclosure; and

FIG. 10 illustrates an example inferencing method for a language AI model in accordance with this disclosure.

### DETAILED DESCRIPTION

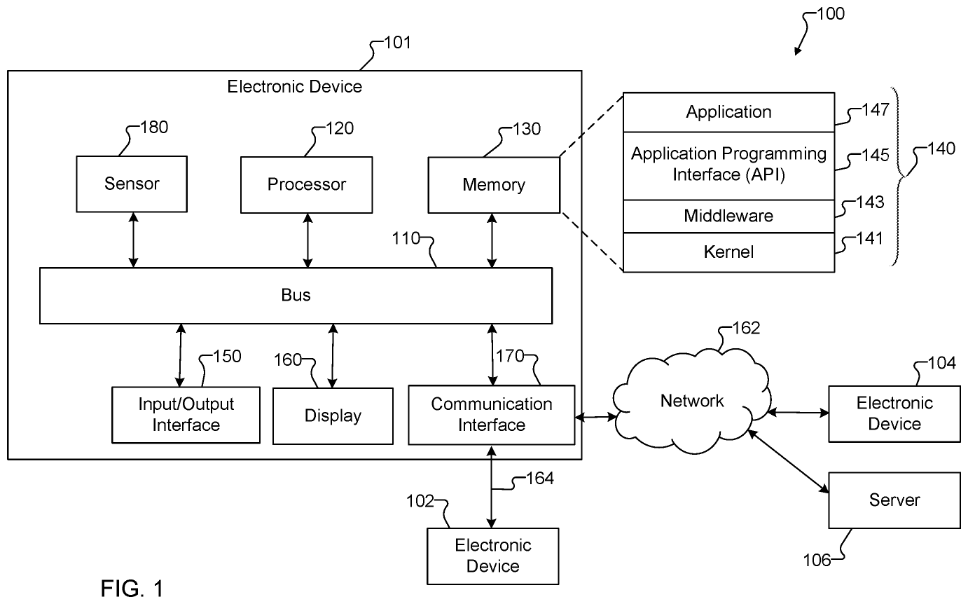

FIGS. 1 through 10, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, text summarization is a natural language processing (NLP) task that involves generating concise summaries of longer documents while preserving key information. It finds applications across various domains such as news aggregation, document summarization and social media analysis. Typically, text summarization approaches are categorized into extractive and abstractive methods based on how the output summary is generated. Extractive methods create summaries by extracting key sentences from the original input while the abstractive methods generate the summaries word-by-word with novel contents. This disclosure provides an efficient abstractive summarizer for edge-devices that can quickly grasp key details from each sentence of the input and generate a concise summary to describe the main points.

Current summarization methods are dominated by large language models (LLMs), their strong understandings, instruction-following capabilities, and generalizations. However, existing approaches, especially with respect to edge-device applications, have several issues. Small-scale models often lack generalizations, and the output has poor performance. Even if LLMs have promising potentials to adapt various use cases with a strong zero-shot or few-shot capability, their sizes usually exceed the memory of edge devices, and running latency prevents the real-time functionality. Current research focuses on utilizing either human evaluators or other scoring metrics, such as ROUGE F-scores, BERTScore, and BartScore. However, those evaluation methods often need a large amount of annotations which are limited to generic scenarios.

To overcome the above issues, this disclosure provides a framework which integrates an automatic scoring module and an online feedback mechanism to enhance the generalization and performance capability for a small-scale transformer-based abstractive summarizer. Meanwhile, to address the on-device usage, during inferencing, both automatic scoring and online feedback modules are eliminated, allowing for deployment of the model to edge devices.

A core motivation of the framework of this disclosure is to enhance the generality and performance of an edge-device friendly automatic abstractive summarization model by integrating an online feedback mechanism conditioned on improvement suggestions from an LLM judger. To meet expectations, a task-driven approach is provided in which the architecture and evaluation are tailored to achieve the best performance for the primary objective, an on-device AI summarizer. The framework of this disclosure addresses various challenges, such as dynamic preference integration throughout the training. The prevalent work usually utilizes Reinforcement Learning (RL) such as RL with Human's Feedback (RLHF), or Direct Preference Optimization (DPO) to enhance the performance for a small-scale models by incorporating a reward policy. However, during the training, such a procedure requires building a preference dataset with multiple preferences for each input which will introduce a large amount of extra annotations. Besides, all preferences are pre-generated and fixed so that they might become outdated and lose the flexibility of real-time adjustment as the model updates. On the other hand, if a dynamic preference collection procedure is incorporated where preference changes over time, it will bring other issues, such as increasing the risk of oscillations that makes it difficult for the model to converge, and the model might not learn a long-term consistency as older feedback might be ignored when new preferences are collected. Therefore, a designed feedback loop needs to compromise the above issues to enhance the model performance.

Another challenge is simple yet efficient training processing. Conventionally, if training with an RL technique, the pipeline follows a “generate-feedback (reward)-update to re-generate” path until the model is optimized with pre-generated preferences, and then this optimized model is sent to be evaluated to present the performance. This learning pattern assumes the pre-generated preferences are the best practice, however, such an assumption eliminates a potential that the preference also can be dynamically updated with respect to the previous response. In addition, during preference optimization steps, the model get updated by measuring how much the generated response is preferred when comparing with the preference, however, such the update is less targeted to improve the model performance.

Another challenge is evaluation design. Existing methods primarily rely on lexical-based evaluation methods, such as ROUGE, BLEU, where they compare word overlap between generated and reference summaries. However, such comparisons fail to capture semantic correctness, coherence, and reasoning quality. As a result, designing evaluation criteria for the LLM-based judger aligns closer with current needs. Besides, the designing needs to consider how to avoid bias in the judger's decisions and also ensure the robustness against edge cases such as noisy and incomplete input.

Another challenge is understanding the capability of an LLM-based judger. LLMs process text token by token, making them good at pattern matching but not true reasoning, which might fail to grasp nuances such as implied meaning, humor, or subtle logical errors in a summary. In addition, an LLM-based judger will need to first understand the evaluation criteria and then process generated summaries along with reference summaries to get final justifications. This brings a challenge for the judger to understand the context and reasoning across long-form content where it might fail to track the important details to get the expected results.

Another challenge is model capacity. Small-scale models lack context understanding and paraphrasing capability due to the limitation of the model capacity and vocabulary size. Meanwhile, the beam widths of their decoders are usually small which results from copying from the input because the highest-probability tokens correspond to those already present in the input.

This disclosure provides a framework configured to train language models and to combine text summary generation, a scoring mechanism, a feedback mechanism, and text summary re-generation into a one-stage learning process. The feedback mechanism is configured to provide real-time feedback for a generated text summary and to dynamically adjust preferences, including an expert preference generator to adaptively generate preferences as the language model updates and a reward system to optimize the language model based on preferences via a training loss function. The scoring mechanism is configured to evaluate the generated text summary based on defined criteria and to utilize an LLM-based judgement process.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to a task-driven AI summarization framework for edge devices.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a task-driven AI summarization framework for edge devices. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to a task-driven AI summarization framework for edge devices.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

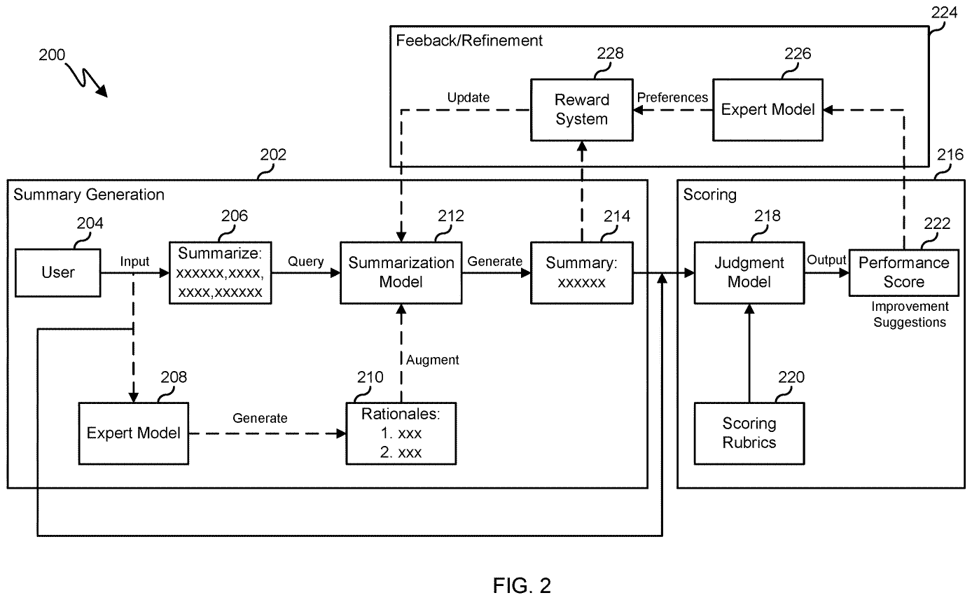

FIG. 2 illustrates an example task-driven AI summarization architecture 200 in accordance with this disclosure. For ease of explanation, the architecture 200 is described as involving the use of the electronic device 101 in the network configuration 100 of FIG. 1. However, the architecture 200 may be used with any other suitable electronic device(s), such as the server 106, and in any other suitable system(s).

The architecture 200 addresses existing challenges as described hereinabove and improves the performance of small-scale AI summarizers for edge devices. The architecture 200 unifies a “generate-scoring-feedback-re-generate” concept into a one-stage learning process to improve the performance while reducing the data preparation complexity. The architecture 200 is designed to primarily address dynamically generated feedback to promote timely updates to the model. Dynamic feedback also avoids pre-generating preferences beforehand so that the architecture 200 is more flexible and efficient to apply for large-scale problems.

As shown in FIG. 2, the architecture 200 includes a summary generation operation 202 that includes receiving an input from a user 204 providing a request 206 to summarize content, such as a text, email, captions, etc. The input is also provided to an expert model 208 that generates rationales 210 using the input. In various embodiments, the expert model can be an LLM. A summarization model 212 receives the request 206 as a query to generate a summary 214, augmented by the rationales provided by the expert model 208.

The architecture 200 also includes a scoring operation 216 that includes using a judgment model 218 that, based on scoring rubrics, outputs a performance score 222. In various embodiments, the judgment model 218 is an LLM. The scoring operation 216 can be performed automatically and for large-scale open-ended summarization problems. The scoring operation 216 uses, in various embodiments, an LLM-based judgement process using the judgment model 218, which significantly reduces the data preparation complexity for large-scale summarization task. The judgment model 218 receives the summary 214 output by the summarization model 212, as well as the original input provided by the user 204. In various embodiments, the judgment model 218 provides a performance score 222 as well as improvement suggestions with respect to the current response which will be further provided to an online feedback operation 224 in order to generate dynamic preferences.

The scoring rubrics 220 used by the judgment model 218 can include customized evaluation metrics. The evaluation metrics are dedicatedly designed for abstractive summarization tasks, and can include various aspects to fully examine both the semantic performance and the word-to-word generation ability of the summarization model 212. These metrics provide a base for the judgment model 218 to provide the performance score 222 and improvement suggestions.

In various embodiments, as noted above, the judgment model 218 is an LLM with Chain-of-Thought (CoT) reasoning enhancement. The benefits of incorporating the LLM judgment model 218 include that it provides more comprehensive understandings and reasons as to why the generated response is good or not, it is a good resource to provide timely justifications according to the current response, and those justifications can be further utilized in the online feedback operation 224. Furthermore, instead of simply using “think step-by-step” as a CoT trigger words, in embodiments of this disclosure, a set of questions can be used to simulate a reasoning process to force the LLM to think progressively to generate more accurate suggestions to precisely reflect the current response. As also described in this disclosure, in various embodiments, a suggestion aggregator can be used with the judgment model 218 to adapt this scoring process with the feedback operation 224, where the suggestion aggregator takes each suggestion from each evaluation metric to finally generate one complete and concise improvement suggestion for the feedback operation 224.

The online feedback operation 224 provides more concise and timely feedback for the current response (the generated summary 214), and enables real-time adjustment of preferences at the time the model gets updated. The online feedback operation 224 includes using another expert model 226, which can be an LLM, that acts as an expert preference generator to generate preferences. Unlike other preference-based optimization methods, the process of this disclosure generates preferences dynamically at each step instead of introducing a large amount of annotations generated beforehand. The expert model 226 (the preference generator) is prompted by the current response, the original input text and improvement suggestions from the LLM judger. Specifically, the expert model 226 promotes the generated preference retaining the long-term consistency from the previous preference that is implied in the current response. Moreover, the improvement suggestions provide a guidance for the expert LLM to generate a preference that emphasizes the drawbacks based on the current response. For example, if the judgment model 218 suggests that the current response has missed one piece of information, then the preference generator should take this information into account so that the generated preference contains more precise details about that information. Lastly, including the original input text is to set a constraint for the preference generator to maintain the primary point on the track to avoid the high risk of the training oscillations. 2) A reward system 228 is configured to optimize the summarization model with respect to the corresponding preference(s) provided by the expert model 226. Since the preference(s) is dynamically generated at each step, that enables a real-time justification from the reward system 228 to update the summarization model 212. This also addresses issues in existing solutions, because the feedback explicitly improves the model performance by enforcing the generated summary to timely align with its preference(s).

It will be noted that, in various embodiments, the expert models 208, 226 and the judgment model 218 can be large-scale LLMs while the summarization model 212 is far smaller and is the target model for deployment on edge devices. Thus, in various embodiments, during inferencing, only the summarization model 212 may be kept.

Although FIG. 2 illustrates one example of a task-driven AI summarization architecture 200, various changes may be made to FIG. 2. For example, various components and functions in FIG. 2 may be combined, further subdivided, replicated, or rearranged according to particular needs. Also, one or more additional components and functions may be included if needed or desired.

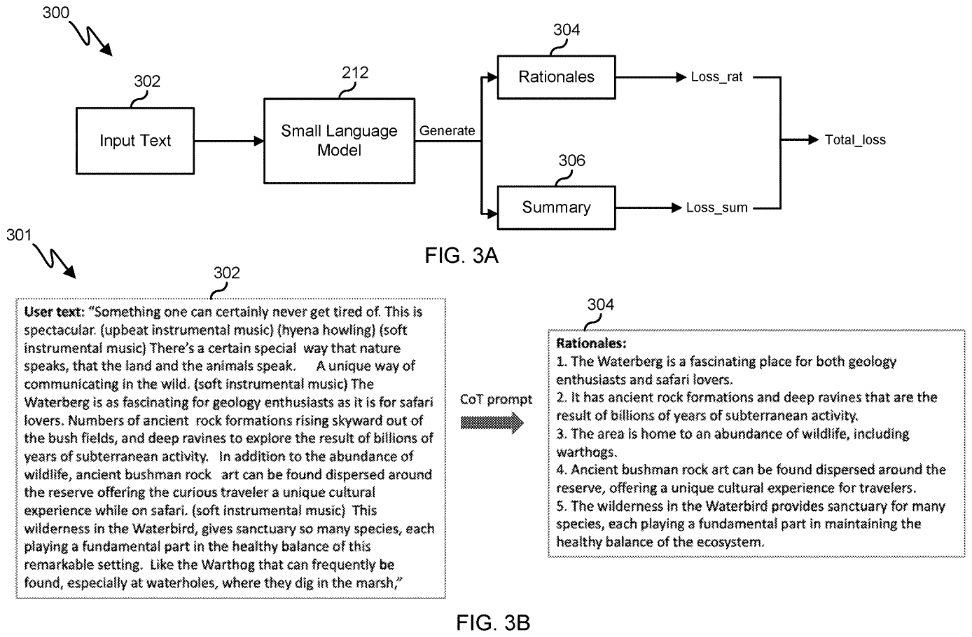

FIG. 3A illustrates an example training process 300 in accordance with this disclosure. For ease of explanation, the process 300 shown in FIG. 3A is described as being implemented on or supported by the electronic device 101 in the network configuration 100 of FIG. 1. It will be understood that the process 300 can be at least a part of the summary generation operation 202 shown in FIG. 2. However, the process 300 shown in FIG. 3A could be used with any other suitable device(s) and in any other suitable system(s), such as when the process 300 is implemented on or supported by the server 106.

Referring also to FIG. 2, in various embodiments, the architecture 200 is used as a two-stage training pipeline, where the first stage is performed with Supervised Fine-Tuning (SFT) while the second stage is performed with Direct Preference Optimization (DPO). Specifically, on the first stage, within the summary generation operation 202, the summarization model 212 is fine-tuned with ground truth(s) generated by the expert model 208. This step provides solid prior knowledge for a small-size language model like the summarization model 212. The summarization model 212 is also shown in FIG. 3A as a small language model that receives a text input 302.

The summary generation operation 202 aims to generate a concise and accurate summary per the user's request. Small-scale language models previously often lacked understanding of the given context and further failed to extract essential points to form a promising and accurate summary. Besides, due to the limitation of the model capacity and vocabulary size, small models tended to produce extractive summaries (copying sentences from the input) rather than generating abstractive outputs. Therefore, apart from the original input text, rationales 304 are incorporated to encourage the model to attend to the details of each sentence to promote generative capacity and reduce copy-paste tendencies.

To meet this goal, the expert model 208 is used with a CoT prompt to capture the key points of the given text as the rationales. Example system and user prompts thus can be as follows:
System prompt=“Based on user's input, let's think step-by-step to capture the whole story, key points and characters.”;
User prompt=“Based on your understanding of this given text:”+<user text>+“, list the key points.”

FIG. 3B illustrates an example generation 301 of example rationales 304 from example input text 302 in accordance with this disclosure.

To maintain deployment efficiency, rationales are only applied during the training stage. Unlike other methods which merge rationales into a user's prompt of the summarization model, the small-scale summarization model 212 of this disclosure does not work with prompt-style. Rather, the summarization model 212 is directly trained to predict rationales along with summaries to enhance the model understanding capability. As shown in FIG. 3A, the small language model 212 can be trained using supervised loss, using both a rationales loss corresponding to the generated rationales 304 and a summary loss corresponding to the generated summary 306. A total loss using both the rationales loss (Loss_rat) and the summary loss (Loss_sum) is used to train the small language model 212, which can be represented as follows.

Total=lossₛᵤₘ(generated summary, GT summary)+a*lossᵣₐₜ(generated rationa, GT rationale)

Afterwards, and as otherwise described in this disclosure, in a second training stage, a fine-tuned summarization model 212 is utilized and the entire framework shown in FIG. 2, including the scoring operation 216 and the feedback operation 224, is performed.

Although FIG. 3A illustrates one example of a training process 300, and FIG. 3B illustrates an example generation 301 of example rationales 304 from example input text 302, various changes may be made to FIGS. 3A and 3B. For example, various components and functions in FIG. 3A may be combined, further subdivided, replicated, or rearranged according to particular needs. Also, one or more additional components and functions may be included if needed or desired. Also, it will be understood that the example input text 302 and the example rationales 304 shown in FIG. 3B are merely for illustrative purposes, and the content of the input text 302 and the example rationales 304 can vary.

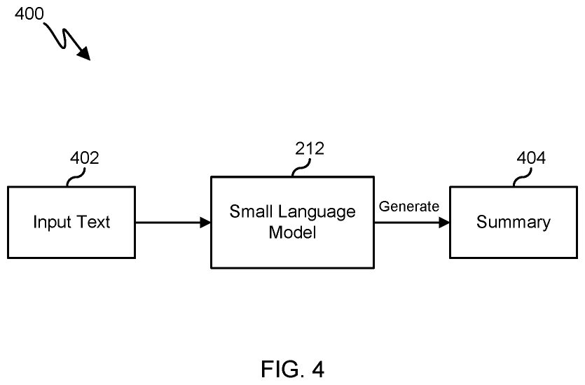

FIG. 4 illustrates an example inferencing process 400 in accordance with this disclosure. For ease of explanation, the process 400 shown in FIG. 4 is described as being implemented on or supported by the electronic device 101 in the network configuration 100 of FIG. 1. However, the process 400 shown in FIG. 4 could be used with any other suitable device(s) and in any other suitable system(s), such as when the process 400 is implemented on or supported by the server 106.

As shown in FIG. 4, after the model is trained, during the inference/deployment stage, only a single summarization model 212 need be kept and all other components can be eliminated, increasing deployability on edge or small form factor devices. The small language model 212 can efficiently receive input text 402 from a user and generate a summary 404 based on the same.

Although FIG. 4 illustrates one example of an inferencing process 400, various changes may be made to FIG. 4. For example, various components and functions in FIG. 4 may be combined, further subdivided, replicated, or rearranged according to particular needs. Also, one or more additional components and functions may be included if needed or desired.

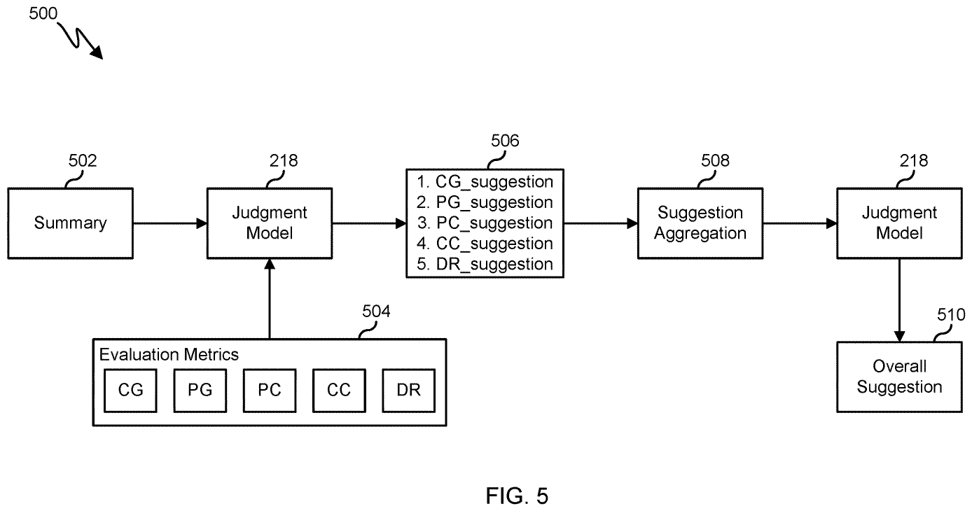

FIG. 5 illustrates an example scoring process 500 in accordance with this disclosure. For ease of explanation, the process 500 shown in FIG. 5 is described as being implemented on or supported by the electronic device 101 in the network configuration 100 of FIG. 1. It will be understood that the process 500 can be at least a part of the scoring operation 216 shown in FIG. 2. However, the process 500 shown in FIG. 5 could be used with any other suitable device(s) and in any other suitable system(s), such as when the process 500 is implemented on or supported by the server 106.

In the scoring process 500, to fully evaluate generated summaries 502 provided by the summarization model 212, various metrics can be used. For example, in some embodiments, evaluation metrics 504 can include five metrics that are used to cover various aspects. Each metric can be given a score from 1 to 5 (where a higher score is better). The five evaluation metrics in this example are used to qualify the performance in both semantic and word-to-word generation levels. Essentially, it is expected that each generated summary should capture the primary story and main point in order to abstractively summarize the given input text. For example, the evaluation metrics 504 can include a character grounding (CG) metric, a plot grounding (PG) metric, and a plot correctness (PC) metric to qualify the semantic meaning of the summary. A completeness and conciseness (CC) metric can also be used to evaluate if the generated summary is incomplete or too lengthy. A Cross-entropy loss trains the model at the token level rather than evaluating the coherence of the entire sequence. This leads to a preference for short, high-probability outputs like copied sentences rather than more creative but lower-confidence outputs. Therefore, even if training loss were to remain low, copying still can occur, contradicting the goal for the summarization model 212 in performing as an abstractive summarizer. To mitigate this, a duplication and repetition (DR) metric can also be used to explicitly penalize the output for the “copying” phenomenon, promoting the judgment model 218 to provide a corresponding suggestion to feedback loop to further update the summarization model.

The judgment model 218 is prompted by taking the generated summary 502, the evaluation metrics 504, and the original input text, to provide a score 506 with an improvement suggestion(s) as a result. As shown in FIG. 5, the score 506 can include one or more suggestions that each can pertain to one of the different evaluation metrics 504. Example specifics on each of the five example metrics are shown below.

### Character Grounding (Score 1-5): Evaluate Whether the Given Summary Refers Correctly to the Characters Present in the Context:

1: Characters are mentioned in text but not in the summary.
2: The summary misidentifies characters by comparing with the given text.
3: The summary does not include any characters' names, but describes them correctly according to the given text.
4: The summary correctly includes some of characters by their names but omits others according to the given text.
5: The summary correctly includes all of characters by their names which appear in the given text.
   Plot Grounding (Score 1-5): Evaluate Whether the Given Summary is Describing the Plot Summary with Respect to the Given Context:
1: The summary contains totally incorrect details of the plot
2: The summary contains mostly incorrect details about the plot.
3: The summary includes irrelevant details affecting the primary points according to the given text.
4: The summary misses several relevant details or contains minor errors without affecting the primary points.
5: The summary provides an accurate plot in a concise and succinct way, without irrelevant descriptions.

### Plot Correctness (Score 1-5): Evaluate Whether the Given Summary Correctly Captures the Primary Plot of the Given Context:

1: The summary is completely inaccurate and irrelevant with respect to the text
2: The summary is mostly inaccurate and irrelevant with respect to the text.
3: The summary contains several accurate elements from the text and also stays relevant to describe the plot.
4: The summary contains the most relevant elements from text, but contains minor errors with respect to the subtitles.
5: The summary contains all relevant and accurate and capturing the primary plot of the given text.
   Conciseness and Completeness Grounding (Score 1-5): Evaluate Whether the Given Summary is Concise while Maintaining the Completeness by Capturing the Primary Point of the Given Context:
1: The summary is incomplete to describe the key point with respect to the given text.
2. The summary contains the partial story, but it does not completely capture the primary story (point) of the given text.
3. The summary is able to capture the most primary story (point) from the given text, but contains minor errors according to the given text.
4. The summary captures the complete primary story (point) from the given text, but produces repeated and redundant detailed contents to lose conciseness.
5. The summary captures the complete primary story and stays concise without producing repeating and redundant contents.

### Duplication & Repetition (Score 1-5): Evaluate Whether the Given Summary Duplicates the Given Subtitles and Repeat Contents:

1: The summary is exactly copied the contents such as sentences or consecutive words from the given text, without any additional contents.
2: The summary is mostly copied from the contents from the input text such as sentences or consecutive words from the given text while containing some additional contents.
3: The summary is directly copied several consecutive words from the given text and contains repetitions within the summary.
4: The summary is not directly copied the contents from the given text but contains repetitions within the summary.

5: The summary is not copied from the contents from the given text and does not have repetitions within the summary.

Further, to enhance the reasoning capability to return a concise and accurate improvement suggestion, the process 500 can also include using a suggestion Automatic Chain-of-Thought (Auto-CoT) technique where a set of explanation prompts are uniquely proposed for each evaluation metric to demonstrate the reasoning process for the judgment model 218. Conventionally, an LLM takes a system prompt and a user's prompt, where the system prompt is to specify the role regarding how the LLM is to assist to complete a task, while the user's prompt is to indicate the task contents. As mentioned above, to fully exploit and enhance the reasoning capability, a set of explanation prompts are used for performing an Auto-CoT process in addition to regular user's prompt for each of the evaluation metrics 504. Example LLM prompting in according with the Auto-COT technique can be as follows.

### System Prompt:

System prompt=“You are a helpful assistant who will evaluate the quality of summary. The user will provide the summary with the corresponding text, delimited in < >. Your role is to evaluate whether the given summary is [evaluation aspect] present in the text. The summary is defined right after users' summary: Rate the summary from 1 to 5 and give justifications by following the below scoring rubrics to make the assessments. Rubrics are defined as [Rubrics for each aspect]”

Here, the system prompt is varied with respect to each evaluation metric. Specifically, “evaluation aspect” refers to “correctly indicate characters,” “correctly describe primary plot,” “correctly include the complete plot,” “concise while complete,” and “directly copy contents” to indicate the role of assisting a task. Then, “Rubrics for each metric” refers to 5 scoring rubrics defined for each metric.

User's prompt—including the generated summary and its corresponding text to describe the current task content:
User prompt=“User's summary:”+generated_summary+“\n”+“Input text:”+“<”+input_text+“>.”

Explanation prompts—explanation prompts are described in each bracket as shown below:
cg=[“Can you identify the characters of each sentence in the given text?”,
   “Can you identify the characters of each sentence in the given summary?”,
   “Can you tell the difference?”,
   “Based on the scoring rubrics, can you output a JSON format with two keys:
      ‘Score’ (Your rate), ‘Improvement Suggestions’ (Your Justification)?”]
pg=[“What are the primary plots from the given text?”, “What elements can you identify to describe the whole plot of the given text?”,
   “Similarly, what are the primary plots from the given summary and what elements can you identify to describe the whole plot?”,
   “Can you tell the difference?”,
   “Based on the scoring rubrics, can you output a JSON format with two keys:
   ‘Score’ (Your rate), ‘Improvement Suggestions’ (Your Justification)?”]
pc=[“What detailed plots are described in the given text?”,
   “What detailed plots are described in the given summary?”,
   “Can you tell the difference and relevance?”,
   “Based on the scoring rubrics, can you output a JSON format with two keys:
      ‘Score’ (Your rate), ‘Improvement Suggestions’ (Your Justification)?”]
cc=[“What story is described in the given text?”,
   “What story is described in the given summary?”,
   “Can you tell the difference?”,
   “Based on the scoring rubrics, can you output a JSON format with two keys:
      ‘Score’ (Your rate), ‘Improvement Suggestions’ (Your Justification)?”]
dr=[“Can you identify any directly copied sentences or contents from the given text to the given summary?”,
   “Can you identify any repetitions in the given summary?”,
   “Based on the scoring rubrics, can you output a JSON format with two keys:
      ‘Score’ (Your rate), ‘Improvement Suggestions’ (Your Justification)?”]

Here, “cg”, “pg”, “pc”, “cc” and “dr”, represent “Character Grounding”, “Plot Grounding”, “Plot Correctness”, “Completeness and Conciseness” and “Duplication & Repetition,” respectively. Through a set of questions, the LLM is prompted to think through the task progressively, to further output an accurate evaluation. Thus, the final user's prompt with CoT techniques can be represented as follows.
User prompt_CoT=[Explanation prompt, User_prompt]

As further shown in FIG. 5, a suggestion aggregation operation 508 is used to collect all improvement suggestions from each metric and prompt the judgment model 218 to produce an overall suggestion 510 which will be used in the online feedback operation 224. In this case, an example system prompt and an example user's prompt can be as follows:
System prompt=“You are a helpful assistant who will generate an overall improvement suggestion. User will provide improvement suggestions from several aspects, your role is to provide an accurate and concise suggestion by aggregating each of them. Each numbering point refers one suggestion of one aspect.”
User_prompt=“1. Character grounding suggestion; 2. Plot grounding suggestion; 3. Plot correctness suggestion; 4. Conciseness and completeness suggestion; 5. Duplication and repetition suggestion;”

Although FIG. 5 illustrates one example of a scoring process 500, various changes may be made to FIG. 5. For example, various components and functions in FIG. 5 may be combined, further subdivided, replicated, or rearranged according to particular needs. Also, one or more additional components and functions may be included if needed or desired.

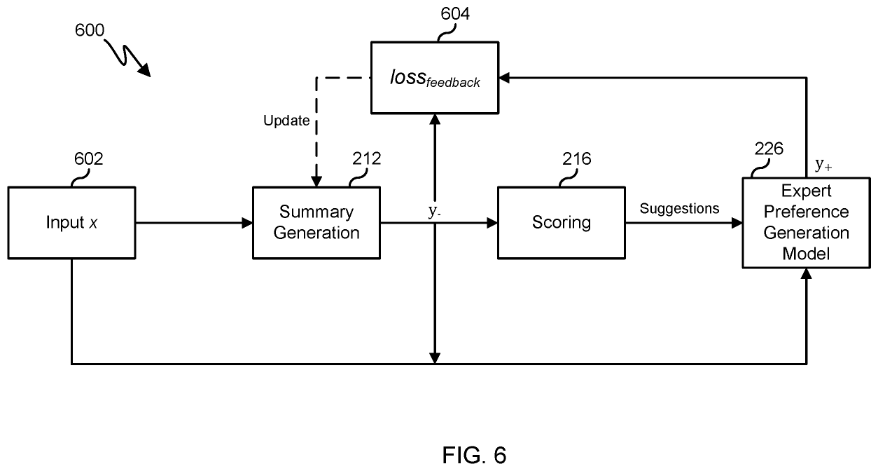

FIG. 6 illustrates an example feedback/refinement process 600 in accordance with this disclosure. For ease of explanation, the process 600 shown in FIG. 6 is described as being implemented on or supported by the electronic device 101 in the network configuration 100 of FIG. 1. It will be understood that the process 600 can be at least a part of the feedback operation 224 shown in FIG. 2. However, the process 600 shown in FIG. 6 could be used with any other suitable device(s) and in any other suitable system(s), such as when the process 600 is implemented on or supported by the server 106.

FIG. 6 denotes (x, y₊, y₋) as input text, preferred response, and current response, respectively. The model input 602 (x) is provided to the summarization model 212 to generate the current response (y₋) which is passed to both the scoring operation 216 and an expert preference generation model 226 (the expert model 226). The expert preference generation model 226 also receives suggestions from the scoring operation 216, as well as the original input 602 (x). The expert preference generation model 226 outputs the preferred response (y₊) based on its inputs. In various embodiments, the process 600 can include dynamically generating preference pairs (preferred, dis-preferred). In this case, preferred responses are generated by the expert preference generation model 226 while dis-preferred is the current response (y₋).

As further shown in FIG. 6, the output of the expert preference generation model 226 is passed to a feedback loss function 604 that is used to provide updates to the summarization model 212, to train and update the summarization model 212. In various embodiments, the feedback loss function 604 can use Direct Preference Optimization (DPO) loss to train the summarization model 212, which can be expressed as follows.

$${L}_{feedback} = {L}_{DPO} ( {π}_{θ} , {π}_{ref} ) = - log σ ( β log \frac{{π}_{θ} ( {y}_{+} \vert x )}{{π}_{ref} ( {y}_{+} \vert x )} ‐ β log \frac{{π}_{θ} ( {y}_{-} \vert x )}{{π}_{ref} ( {y}_{-} \vert x )} )$$

Here, π_{θ} is the model to be fine-tuned (the summarization model 212), π_{ref} is a reference model, initialized the same as π_{θ}, but kept frozen during training, x is the model input, y₊ is the dynamic preference response from the expert preference generation model 226, y₋ is the current response from the summarization model 212, and β is a hyper-parameter that controls the amount of divergence from π_{ref}.

Although FIG. 6 illustrates one example of a feedback/refinement process 600, various changes may be made to FIG. 6. For example, various components and functions in FIG. 6 may be combined, further subdivided, replicated, or rearranged according to particular needs. Also, one or more additional components and functions may be included if needed or desired.

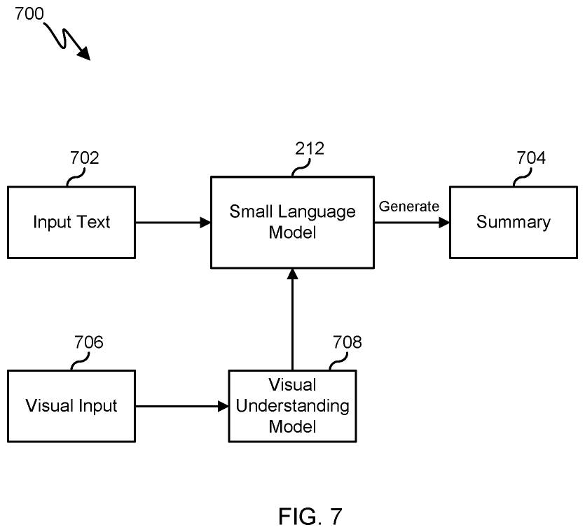

FIG. 7 illustrates an example summarization process 700 incorporating visual understanding in accordance with this disclosure. For ease of explanation, the process 700 shown in FIG. 7 is described as being implemented on or supported by the electronic device 101 in the network configuration 100 of FIG. 1. However, the process 700 shown in FIG. 7 could be used with any other suitable device(s) and in any other suitable system(s), such as when the process 700 is implemented on or supported by the server 106.

In some embodiments, during inferencing, visual understanding can be incorporated in the summarization process using the small language model 212. As shown in FIG. 7, input text 702 is provided to the small language model 212 to generate a summary 704. Additionally, a visual input 706 is provided to a visual understanding model 708. The visual understanding model 708 enhances the versality and generalization of the small language model 212, enabling more comprehensive understanding capability and application of the small language model 212 to more complex scenes. In this example, the evaluation rubrics can also be updated with respect to both visual and language inputs.

Although FIG. 7 illustrates one example of a summarization process 700 incorporating visual understanding, various changes may be made to FIG. 7. For example, various components and functions in FIG. 7 may be combined, further subdivided, replicated, or rearranged according to particular needs. Also, one or more additional components and functions may be included if needed or desired.

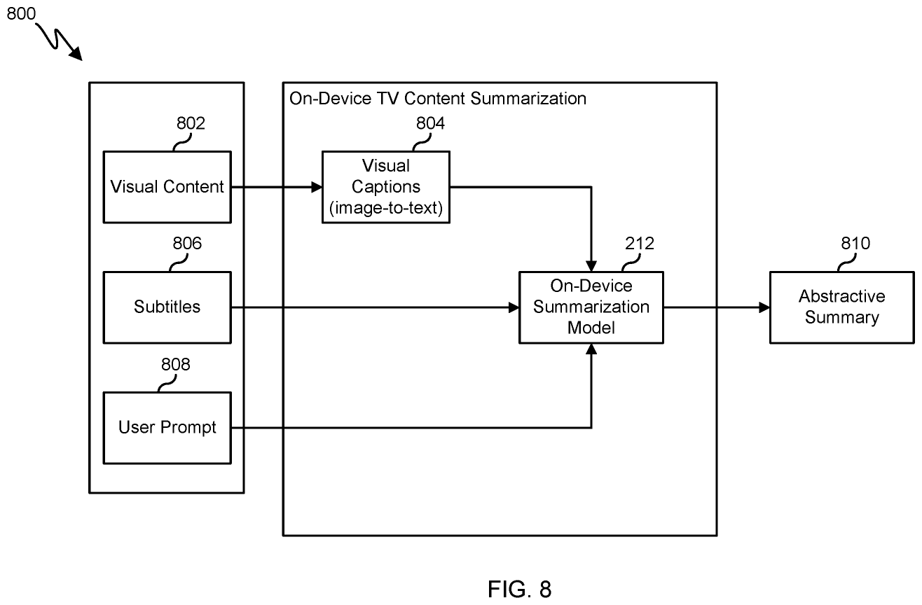

FIG. 8 illustrates an example on-device content summarization process 800 in accordance with this disclosure. For ease of explanation, the process 800 shown in FIG. 8 is described as being implemented on or supported by the electronic device 101 in the network configuration 100 of FIG. 1. However, the process 800 shown in FIG. 8 could be used with any other suitable device(s) and in any other suitable system(s), such as when the process 800 is implemented on or supported by the server 106.

As one example of how the summarization model 212 of this disclosure can be used, FIG. 8 shows using the summarization model 212 on a TV device to perform content and event highlight summarization, e.g., using the summarization model 212 to perform live TV content summarization, and key events detection and summarization while considering the content and subtitles. As shown in FIG. 8, visual content 802 is provided to a visual captions operation 804 that converts the visual content from images to text, and provides the text to the summarization model 212. A subtitles operation 806 provides subtitles for the content to the summarization model 212. A user prompt 808 is also provided to the summarization model 212 asking the summarization model 212 to summarize the visual content. The summarization model 212 then outputs an abstractive summary 810 of the content to the user.

Although FIG. 8 illustrates one example of an on-device content summarization process 800, various changes may be made to FIG. 8. For example, various components and functions in FIG. 8 may be combined, further subdivided, replicated, or rearranged according to particular needs. Also, one or more additional components and functions may be included if needed or desired. For instance, the process 800 could use the visual understanding model 708 as, or in addition to, the visual captions operation 804.

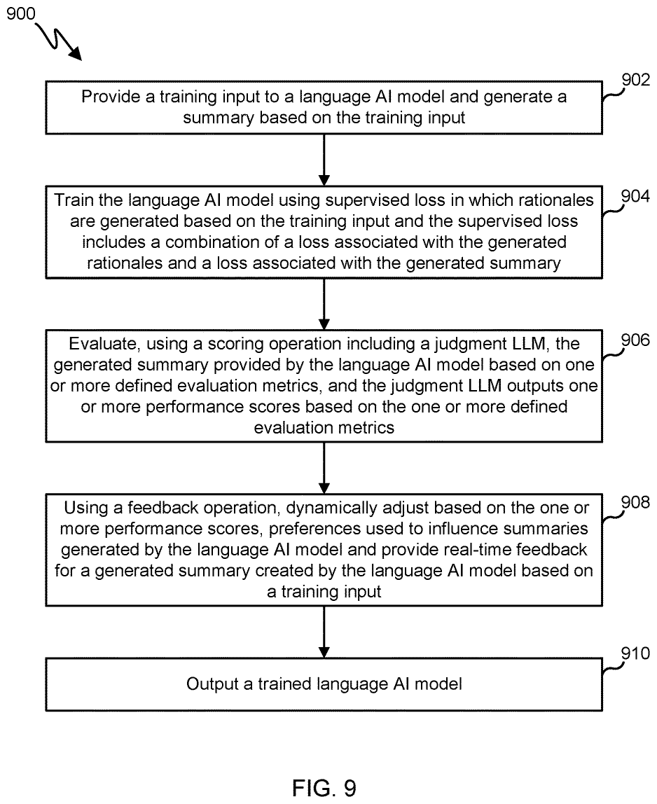

FIG. 9 illustrates an example training method 900 for a language AI model in accordance with this disclosure. For ease of explanation, the method 900 shown in FIG. 9 is described as being performed using the electronic device 101 in the network configuration 100 of FIG. 1. It will be understood that the method 900 can be performed using at least the architecture 200. However, the method 900 could be performed using any other suitable device(s), such as the server 106, and in any other suitable system(s).

At step 902, a training input is provided to a language AI model and a summary is generated by the linage AI model based on the training input. At step 904, the language AI model is trained using supervised loss in which rationales are generated based on the training input and the supervised loss includes a combination of a loss associated with the generated rationales and a loss associated with the generated summary.

At step 906, the generated summary provided by the language AI model is evaluated, using a scoring operation including a judgment LLM, based on one or more defined evaluation metrics, and the judgment LLM outputs one or more performance scores based on the one or more defined evaluation metrics. At step 908, preferences used to influence summaries generated by the language AI model are dynamically adjusted using a feedback operation, based on the one or more performance scores, and real-time feedback is provided using the feedback operation for a generated summary created by the language AI model based on training input feedback. At step 910, a trained language AI model is output.

Although FIG. 9 illustrates one example of a training method 900 for a language AI model, various changes may be made to FIG. 9. For example, while shown as a series of steps, various steps in FIG. 9 could overlap, occur in parallel, occur in a different order, or occur any number of times (including zero times).

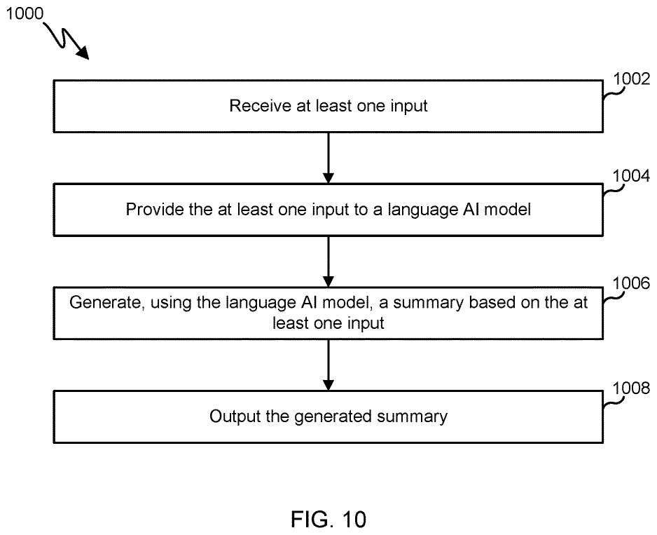

FIG. 10 illustrates an example inferencing method 1000 for a language AI model in accordance with this disclosure. For ease of explanation, the method 1000 shown in FIG. 10 is described as being performed using the electronic device 101 in the network configuration 100 of FIG. 1. However, the method 1000 could be performed using any other suitable device(s), such as the server 106, and in any other suitable system(s).

At step 1002, at least one input is received. As described in this disclosure, the at least one input can be a user prompt and content to be summarized, such as text content, visual, etc. At step 1004, the at least one input is provided to a language artificial intelligence (AI) model. At step 1006, a summary based on the at least one input is generated using the language AI model. At step 1008, the generated summary is output.

As described in this disclosure, in various embodiments, the language AI model can be trained using a combination of a summary generation operation, a scoring operation, a feedback operation, and a summary re-generation operation. As described in this disclosure, in various embodiments, the feedback operation can dynamically adjust preferences used to influence summaries generated by the language AI model and provides real-time feedback for a generated summary created by the language AI model based on a training input.

As described in this disclosure, in various embodiments, the summary generation operation can include training the language AI model using supervised loss in which rationales are generated based on the training input and the supervised loss includes a combination of a loss associated with the generated rationales and a loss associated with the generated summary.

As described in this disclosure, in various embodiments, the scoring operation can evaluate, using a judgment large language model (LLM), the generated summary provided by the language AI model based on one or more defined evaluation metrics, and the judgment LLM can output one or more performance scores based on the one or more defined evaluation metrics. As described in this disclosure, in various embodiments, the one or more defined evaluation metrics can include one or more of a character grounding metric, a plot grounding metric, a plot correctness metric, a conciseness and completeness metric, and a duplication and repetition metric.

As described in this disclosure, in various embodiments, the scoring operation can provide, using the judgment LLM, one or more suggestions based on the one or more defined evaluation metrics, and the one or more suggestions can be aggregated into an overall suggestion that is used by the feedback operation to dynamically adjust the preferences. As described in this disclosure, in various embodiments, the feedback operation can include an expert preference generation model configured to adaptively generate preferences as language model updates and a reward system to optimize the language model based on the generated preferences via a feedback loss function.

As described in this disclosure, in various embodiments, visual information can be provided, using a visual understanding model, to the language AI model and the summary can be generated based on the input using the visual information.

Although FIG. 10 illustrates one example of an inferencing method 1000 for a language AI model, various changes may be made to FIG. 10. For example, while shown as a series of steps, various steps in FIG. 10 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving an input using a language artificial intelligence (AI) model; and
outputting a summary based on the input using the language AI model,
wherein the language AI model is trained using a combination of a summary generation operation, a scoring operation, a feedback operation, and a summary re-generation operation, and
wherein the feedback operation dynamically adjusts preferences used to influence summaries generated by the language AI model and provides real-time feedback for a generated summary created by the language AI model based on a training input.

2. The method of claim 1, wherein the summary generation operation trains the language AI model using supervised loss in which rationales are generated based on the training input and the supervised loss includes a combination of a loss associated with the generated rationales and a loss associated with the generated summary.

3. The method of claim 2, wherein the scoring operation evaluates, using a judgment large language model (LLM), the generated summary provided by the language AI model based on one or more defined evaluation metrics, and the judgment LLM outputs one or more performance scores based on the one or more defined evaluation metrics.

4. The method of claim 3, wherein the one or more defined evaluation metrics include one or more of:
a character grounding metric;
a plot grounding metric;
a plot correctness metric;
a conciseness and completeness metric; and
a duplication and repetition metric.

5. The method of claim 3, wherein the scoring operation provides, using the judgment LLM, one or more suggestions based on the one or more defined evaluation metrics, and wherein the one or more suggestions are aggregated into an overall suggestion that is used by the feedback operation to dynamically adjust the preferences.

6. The method of claim 5, wherein the feedback operation includes an expert preference generation model configured to adaptively generate preferences as language model updates and a reward system to optimize the language model based on the generated preferences via a feedback loss function.

7. The method of claim 1, further comprising:
providing, using a visual understanding model, visual information to the language AI model; and
generating the summary based on the input using the visual information.

8. An electronic device comprising:
at least one processing device configured to:
receive an input using a language artificial intelligence (AI) model; and
output a summary based on the input using the language AI model,
wherein the language AI model is trained using a combination of a summary generation operation, a scoring operation, a feedback operation, and a summary re-generation operation, and
wherein the feedback operation dynamically adjusts preferences used to influence summaries generated by the language AI model and provides real-time feedback for a generated summary created by the language AI model based on a training input.

9. The electronic device of claim 8, wherein the summary generation operation trains the language AI model using supervised loss in which rationales are generated based on the training input and the supervised loss includes a combination of a loss associated with the generated rationales and a loss associated with the generated summary.

10. The electronic device of claim 9, wherein the scoring operation evaluates, using a judgment large language model (LLM), the generated summary provided by the language AI model based on one or more defined evaluation metrics, and the judgment LLM outputs one or more performance scores based on the one or more defined evaluation metrics.

11. The electronic device of claim 10, wherein the one or more defined evaluation metrics include one or more of:
a character grounding metric;
a plot grounding metric;
a plot correctness metric;
a conciseness and completeness metric; and
a duplication and repetition metric.

12. The electronic device of claim 10, wherein the scoring operation provides, using the judgment LLM, one or more suggestions based on the one or more defined evaluation metrics, and wherein the one or more suggestions are aggregated into an overall suggestion that is used by the feedback operation to dynamically adjust the preferences.

13. The electronic device of claim 12, wherein the feedback operation includes an expert preference generation model configured to adaptively generate preferences as language model updates and a reward system to optimize the language model based on the generated preferences via a feedback loss function.

14. The electronic device of claim 8, wherein the at least one processing device is further configured to:
provide, using a visual understanding model, visual information to the language AI model; and
generate the summary based on the input using the visual information.

15. A non-transitory machine-readable medium containing instructions that when executed cause at least one processor of an electronic device to:
receive an input using a language artificial intelligence (AI) model; and
output a summary based on the input using the language AI model,
wherein the language AI model is trained using a combination of a summary generation operation, a scoring operation, a feedback operation, and a summary re-generation operation, and
wherein the feedback operation dynamically adjusts preferences used to influence summaries generated by the language AI model and provides real-time feedback for a generated summary created by the language AI model based on a training input.

16. The non-transitory machine-readable medium of claim 15, wherein the summary generation operation trains the language AI model using supervised loss in which rationales are generated based on the training input and the supervised loss includes a combination of a loss associated with the generated rationales and a loss associated with the generated summary.

17. The non-transitory machine-readable medium of claim 16, wherein the scoring operation evaluates, using a judgment large language model (LLM), the generated summary provided by the language AI model based on one or more defined evaluation metrics, and the judgment LLM outputs one or more performance scores based on the one or more defined evaluation metrics.

18. The non-transitory machine-readable medium of claim 17, wherein the one or more defined evaluation metrics include one or more of:
a character grounding metric;
a plot grounding metric;
a plot correctness metric;
a conciseness and completeness metric; and
a duplication and repetition metric.

19. The non-transitory machine-readable medium of claim 17, wherein the scoring operation provides, using the judgment LLM, one or more suggestions based on the one or more defined evaluation metrics, and wherein the one or more suggestions are aggregated into an overall suggestion that is used by the feedback operation to dynamically adjust the preferences.

20. The non-transitory machine-readable medium of claim 19, wherein the feedback operation includes an expert preference generation model configured to adaptively generate preferences as language model updates and a reward system to optimize the language model based on the generated preferences via a feedback loss function.
